(19) United States
(12) Patent Application Publication
(10) Pub. No.: US 2021/0245341 A1
(43) Pub. Date: Aug. 12, 2021

(54) JIG FOR ASSEMBLY OF COMPONENTS

(71) Applicant: Honda Motor Co., Ltd., Tokyo (JP)

(72) Inventors: Benjamin B. MacArthur, Barrie (CA); Benjamin Douglas DeBoer, Ancaster (CA)

(21) Appl. No.: 16/787,216

(22) Filed: Feb. 11, 2020

(51) Int. Cl. B25B 27/08; F16C 11/06

(52) U.S. Cl. CPC B25B 27/08; F16C 11/0685

(57) ABSTRACT

A jig for assembly of assembly components is provided. The jig includes a base portion and an upright portion coupled to the base portion. The jig further includes a biasing device having a first end and a second end. The biasing device is translatable between a biased state and an unbiased state. The first end of the biasing device is rotatably coupled to at least one of the upright portion or the base portion, and the second end is configured to be translatable between a biased state and an unbiased state. The jig further includes a support member comprising a first end and a second end. The first end of the support member is rotatably coupled to at least one of the upright portion and the second end of the biasing device.

### BACKGROUND

Use of lift assists to perform different assembly operations is common. The lift assist may have provisions to lift and assemble different assembly components with an assembly interface. When an assembly component is brought toward the assembly interface using the lift assist, the assembly component may unintentionally strike a nearby component. For example, an unintentional strike may negatively affect an adjacent fastener and/or dent or mar a nearby component.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a jig. The jig may include a base portion and an upright portion coupled to the base portion. The jig may further include a biasing device having a first end and a second end. The biasing device may be translatable between a biased state and an unbiased state. The first end may be rotatably coupled to at least one of the upright portion or the base portion. The jig may further include a support member comprising a first end and a second end. The first end of the support member may be rotatably coupled to at least one of the upright portion and the second end of the biasing device.

Another exemplary aspect of the disclosure provides a jig for installation of a drive shaft. The jig may include a base portion and an upright portion coupled to the base portion. The jig may further include a biasing device having a first end and a second end. The first end may be rotatably coupled to at least one of the upright portion or the base portion. The biasing device may be translatable between a biased state and an unbiased state. The jig may further include a support member comprising a first end and a second end. The first end of the support member may be rotatably coupled to at least one of the upright portion and the second end of the biasing device. When a drive shaft is placed on a portion of the support member, the drive shaft may be configured to apply a substantially downward force on the portion of the support member to translate the biasing device from the unbiased state to the biased state.

Another exemplary aspect of the disclosure provides a method of assembling vehicle chassis components which includes a lower ball joint that may be configured to be coupled to a first part of a knuckle and a drive shaft that may be configured to be coupled to a second part of the knuckle. The method may include positioning a jig that includes a biasing device, adjacent to the knuckle. The jig may be configured to provide access to the first part of the knuckle when the biasing device is in an unbiased state. Further, the jig may be configured to provide access to the second part of the knuckle and to prevent a contact between the drive shaft and the first part of the knuckle when the biasing device is in a biased state. The method may further include coupling the lower ball joint to the first part of the knuckle while the biasing device is in the unbiased state, using at least one fastener and a cotter pin configured to secure the at least one fastener. The method may further include positioning the drive shaft against the jig and forcing the biasing device to translate from the unbiased state to the biased state. The method may further include coupling the drive shaft to the second part of the knuckle.

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 is a diagram that illustrates a first exemplary embodiment of a jig for assembly of components.

FIG. 2 is a diagram that illustrates a second exemplary embodiment of a jig for assembly of components.

FIG. 3 is a diagram that illustrates an exemplary arrangement of the jig of FIG. 1 with an assembly interface, in accordance with an embodiment of the disclosure.

FIGS. 4A, 4B, and 4C are diagrams that collectively illustrate exemplary operations for installation of assembly components into an assembly interface using the jig of FIG. 1, in accordance with an embodiment of the disclosure.

FIG. 5 is a diagram that illustrates an exemplary arrangement of a knuckle and the jig of FIG. 1 for assembly of a drive shaft with the knuckle, in accordance with an embodiment of the disclosure.

FIGS. 6A, 6B, and 6C are diagrams that collectively illustrate exemplary operations for assembly of a drive shaft with a knuckle using the exemplary arrangement of FIG. 5, in accordance with an embodiment of the disclosure.

FIG. 7 is a flowchart that illustrates an exemplary method for assembling a lower ball joint and a drive shaft with a knuckle, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed jig. Exemplary aspects of the disclosure may provide a jig, which may be configured to allow an operator to safely couple an assembly component together with an assembly interface. The jig may be a flexible, no scratch apparatus that may protect a cotter pin or other types of fasteners on the assembly interface when coupling the assembly component together with the assembly interface.

The jig may include a base portion, an upright portion, a biasing device, and a support member. The base portion may be configured to fix the jig firmly to a stationary surface so that the jig may be set at an upright position. The upright portion may be coupled to the base portion and may be configured to provide a support to the support member. The support member coupled with the biasing device may be configured to provide a first assembly component access to the assembly interface, when the biasing device is in an unbiased state.

After the first assembly component is secured to the assembly interface using a cotter pin, a second assembly component may be placed on the support member with a substantially downward force, causing the biasing device to translate from the unbiased state to a biased state. In the biased state, the support member coupled with the biasing device may be configured to provide the second assembly component access to the assembly interface. At the same time, the support member may prevent the second assembly component from contacting the first assembly component while the first assembly component is being coupled to the assembly interface. As a result, the support member may prevent the second assembly component from unintentionally striking the first assembly component that was previously coupled to the assembly interface.

In cases where the biasing device is in the biased state, the biasing device may be configured to be inclined with respect to the upright portion. When inclined, the biasing device may angularly support the support member to prevent any wobble or deflection during installation.

The upright portion of the jig may include openings that include fasteners, which when moved, may allow a human operator to adjust the distance between the support member and the base portion so that the support member may suitably align and assemble the second assembly component from one of a variety of distance levels. This may prevent a need to have a different jig for a different size/of assembly interface that may be positioned at different distance levels. Also, the support member may include a pivotable end portion, which may be configured to be removable from the support member. So, if the pivotable end portion is worn during installation, the pivotable end portion can be replaced individually rather than completely replacing the support member or the jig.

For example, when assembling a drive shaft (as the assembly component) and a lower ball joint with a knuckle (as the assembly interface), the jig may provide lower ball joint access to a first part of the knuckle in the unbiased state of the biasing device. After the lower ball joint is secured to the knuckle using a cotter pin, the drive shaft may be placed on the support member of the jig with a substantially downward force, causing the biasing device of the jig to translate from the unbiased state to the biased state. As the drive shaft may be brought towards the knuckle, the support member may protect the cotter pin on the lower ball joint. Therefore, the jig may allow the drive shaft to be assembled with the knuckle spline without any chance of striking the cotter pin and knocking it out. When the drive shaft is being loaded into the knuckle, the jig allows the lift assist to install the drive shaft and remove the empty lift assist without any issues.

Reference will now be made in detail to specific aspects or features, examples of which are illustrated in the accompanying drawings. Wherever possible, corresponding or similar reference numbers will be used throughout the drawings to refer to the same or corresponding parts.

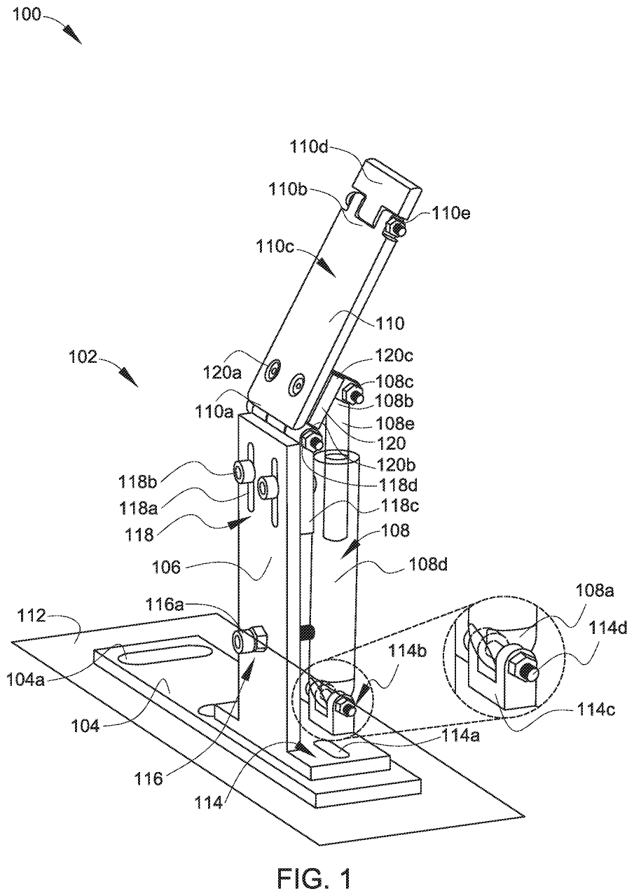

FIG. 1 is a diagram that illustrates an exemplary jig for assembly of components, in accordance with a first embodiment of the disclosure. With reference to FIG. 1, there is shown a diagram 100 of a jig 102, which may be used in environments, such as on an assembly line or on a shop floor of an automobile assembling plant. During assembly, the jig 102 may be configured to support the weight of an assembly component, for example, a drive shaft for a vehicle. While supporting the weight, a human operator may be able to maneuver the assembly component to align and couple with an assembly interface, for example, a knuckle for the drive shaft.

The jig 102 may include a base portion 104, an upright portion 106, a biasing device 108, and a support member 110. The base portion 104 may have a suitable structure, design, or a shape profile that may be configured to hold the jig 102 firmly to a stationary surface 112 and set the jig 102 in an upright position. The base portion 104 may include one or more openings 104a which may be configured to receive a first fastener (not shown) to fasten the base portion 104 to the stationary surface 112. Alternatively, the base portion 104 may include suction cups (not shown) to allow the base portion 104 to form a firm grip with the stationary surface 112. In an embodiment, the base portion 104 may be removably coupled with the upright portion 106 so that the upright portion 106 can be selectively fastened to one of the one or more opening 104a located in the base portion 104. Alternatively, the base portion 104 may be integrally formed as one piece with the upright portion 106.

The upright portion 106 may be configured to be coupled to the base portion 104 and may support the biasing device 108 and the support member 110. In FIG. 1, the upright portion 106 is shown to have a substantially L-shaped structure, which rigidly couples with the base portion 104. However, the present disclosure may not be so limiting and in at least one embodiment, the upright portion 106 may have another suitable structure, such as, but are not limited to, a substantially I-shaped structure or a substantially H-shaped structure.

The upright portion 106 may include an upright fixing section 114, a biasing fixing section 116, and a support fixing section 118. The upright fixing section 114 may be parallelly disposed on the base portion 104 and may include one or more openings 114a which may be aligned with the one or more openings 104a on the base portion 104, to affix the upright fixing section 114 to the base portion 104. The upright fixing section 114 may further an anchor member 114b which may be disposed proximally to the one or more openings 114a. In an embodiment, the anchor member 114b may include a fork end 114c that may be configured to be coupled to the biasing device 108 through a suitable fastener 114d. The anchor member 114b may have a substantially fork-shaped knuckle joint to allow the biasing device 108 to have one or more degrees of freedom. Alternatively, the anchor member 114b may include another suitable joint, such as, but not limited to, a universal joint or a ball joint.

The biasing fixing section 116 of the upright portion 106 may be substantially perpendicular to the upright fixing section 114 and may be disposed substantially parallel to the biasing device 108. The biasing fixing section 116 may be coupled to the biasing device 108 through a suitable fastener 116a. While the biasing device 108 translates from an unbiased state to a biased state, the biasing fixing section 116 may be configured to hold the biasing device 108 so as to prevent wobbling of the support member 110.

The support fixing section 118 of the upright portion 106 may be substantially perpendicular to the upright fixing section 114 and may be disposed substantially adjacent to the support member 110. The support fixing section 118 of the upright portion 106 may include one or more openings 118a that may be configured to receive a second fastener 118b for coupling the upright portion 106 to the support member 110. In an embodiment, the second fastener 118b may be configured to slide in the one or more openings 118a to adjust a distance between the support member 110 and the base portion 104. The upright portion 106 may include a suitable fastener 118c to rotatably couple the support member 110 to a sliding section 118d. For example, if the second fastener 118b slides in the one or more openings 118a, the sliding section 118d may slide along with the second fastener 118b to adjust the distance between the support member 110 and the base portion 104. By adjusting the distance, the support member 110 may hold and guide assembly components up to a variety of distance levels (not shown) without any wobble or deflection.

The biasing device 108 may have a suitable structure, design, or a shape profile that may be configured to provide a support to the support member 110 for receiving the assembly component and for guiding the assembly component in the assembly interface. The biasing device 108 may have a first end 108a and a second end 108b. The first end 108a may be rotatably coupled to at least one of: the upright portion 106 or the base portion 104. In an embodiment, the first end 108a of the biasing device 108 may be rotatably coupled to the fork end 114c of the anchor member 114b that may be disposed in the upright fixing section 114 of the upright portion 106. The first end 108a of the biasing device 108 may form a substantially eye-shaped profile that may be aligned with the fork end 114c of the anchor member 114b and fastened through the suitable fastener 114d. In another embodiment, the first end 108a of the biasing device 108 may be directly coupled to the one or more openings 104a of the base portion 104 through a suitable fastener (not shown). The second end 108b of the biasing device 108 may be coupled to the support member 110 through a suitable fastener 108c. Also, the biasing device 108 may be translatable between a biased state and an unbiased state.

The biasing device 108 may include a cylinder 108d and a piston 108e slidably biased with the cylinder 108d. Also, in some implementations, a spring (not shown) may be loaded into the cylinder 108d to allow the piston 108e of the biasing device 108 to extend (or contract) when in the unbiased state and contract (or extend) when in the biased state. The spring may be selected based on a stiffness parameter to suitably support the support member 110 between the biased state and the unbiased state, without any deflection. In this implementation, the first end 108a of the biasing device 108 may correspond to one end of the cylinder 108d and the second end 108b of the biasing device 108 may correspond to an end of the piston 108e coupled to the support member 110. The cylinder 108d of the biasing device 108 may be configured to be coupled with the biasing fixing section 116 of the upright portion 106 through the suitable fastener 116a.

In another embodiment, the biasing device 108 may include at least one of: a pneumatic cylinder, a hydraulic cylinder, and a spring (not shown). In another embodiment, the biasing device 108 may be substantially a spring (not shown). The spring may have one end coupled to the fork end 114c of the anchor member 114b and another end coupled with the support member 110 through the suitable fastener 108c. The spring may be of a suitable spring constant to support the support member 110 when the biasing device 108 is in the biased state. Specifically, the spring should be able to support the support member 110 when a substantially downward force is applied on the support member 110, causing the biasing device 108 to translate from the unbiased state to the biased state. In such an implementation, the unbiased state of the spring may correspond to an uncompressed state of the spring and the biased state of the spring may correspond to a compressed state of the spring. In at least one embodiment, the spring may be replaceable in accordance with a shape/size of the assembly component and/or the assembly interface.

In at least one embodiment, the biasing device 108 may be configured to be positioned substantially parallel to the upright portion 106 when the biasing device 108 is in the unbiased state. Similarly, the biasing device 108 may be configured to be inclined with respect to the upright portion 106 when the biasing device 108 is in the biased state. As a result, the biasing device 108 may angularly support the support member 110 so that the support member 110 may not wobble even when the biasing device 108 is inclined and may firmly hold the assembly component in the assembly interface without any deflection.

The support member 110 may have a suitable structure, design, or a shape profile that may be configured to provide a support to the assembly component and to allow a human operator to steadily guide the assembly component in the assembly interface. The support member 110 may include a first end 110a, a second end 110b, and a portion 110c. The first end 110a may be rotatably coupled to at least one of: the upright portion 106 and the second end 108b of the biasing device 108. In at least one embodiment, the jig 102 may further include a pivotable end portion 110d that may be rotatably coupled to the second end 110b of the support member 110 through a suitable fastener 110e. The pivotable end portion 110d may be configured to be removable from the second end 110b to ease a replacement of the pivotable end portion 110d if the pivotable end portion 110d is worn.

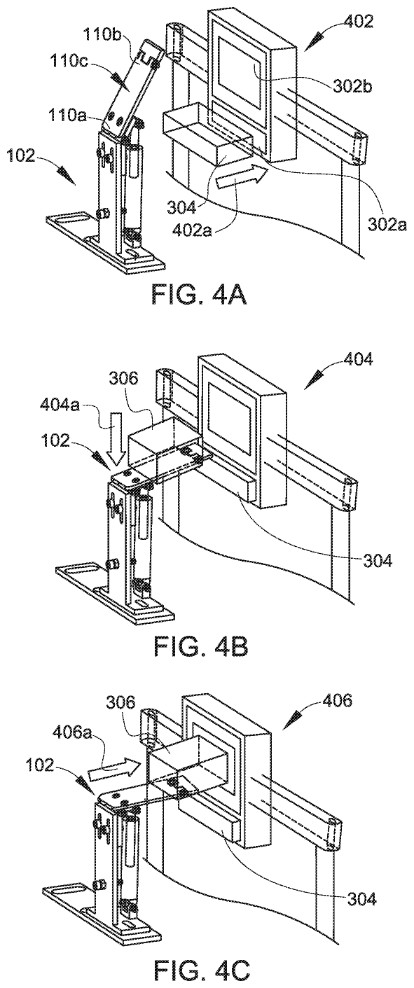

In at least one embodiment, when a substantially downward force is configured to be applied to the portion 110c of the support member 110, the biasing device 108 may be configured to translate from the unbiased state to the biased state (as shown, for example, in FIGS. 4A, 4B, and 4C). Similarly, when the substantially downward force is released from the portion 110c of the support member 110, the biasing device 108 may be configured to return from the biased state to the unbiased state.

In an embodiment, the support member 110 may further include a support bar 120 that may be coupled to the first end 110a through a suitable fastener 120a. The support bar 120 may include a first member 120b and a second member 120c. The first member 120b may be configured to be coupled with the upright portion 106. For example, the first member 120b of the support bar 120 may be configured to be rotatably coupled with the sliding section 118d of the upright portion 106 through the suitable fastener 118c. Similarly, the second member 120c of the support bar 120 may be configured to be rotatably coupled with the second end 108b of the biasing device 108 through the suitable fastener 108c.

It should be noted that the jig 102, as shown in FIG. 1, is merely an example. The present disclosure may also be applicable to other variations of the jig 102, without deviating from the scope of the disclosure. For example, such variations may include, but not limited to, an autonomous robotic jig or a translatable jig that may be configured to move along a guide rail (not shown) to hold and guide the assembly component in the assembly interface. The jig 102 may be made of material(s) that may facilitate an operator to easily lift and carry the jig 102 to the assembly interface.

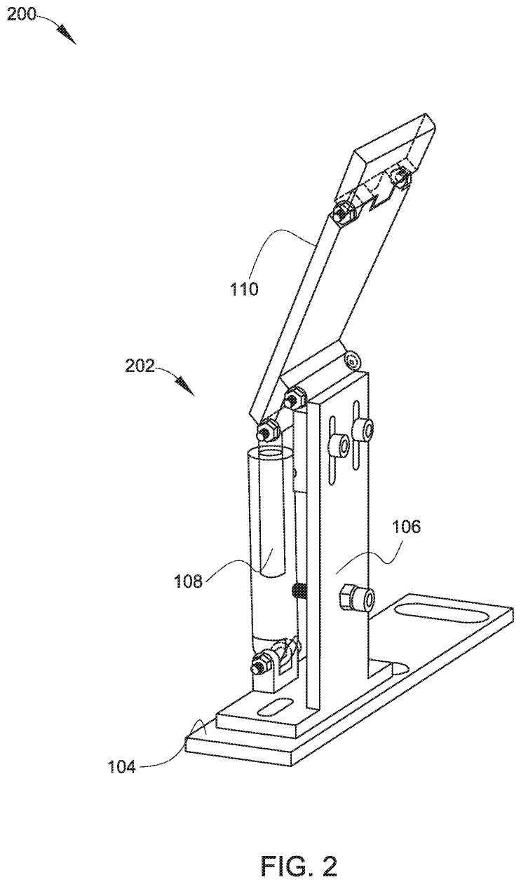

FIG. 2 is a diagram that illustrates an exemplary jig for assembly of components, in accordance with an embodiment of the disclosure. FIG. 2 is explained in conjunction with elements from FIG. 1. With reference to FIG. 2, there is shown a diagram 200 of the jig 202. The jig 202 may include the base portion 104, the upright portion 106, the biasing device 108, and the support member 110. The elements shown in the FIG. 2 may be same as elements described in FIG. 1. However, as compared to the jig 102, there may be a change in the positional arrangement of the biasing device 108 and the support member 110 in the jig 202.

As shown, in FIG. 2, the upright portion 106 may be coupled between the first end 110a of the support member 110 and the second end 110b of the support member 110. Whereas, in FIG. 1, the second end 108b of the biasing device 108 may be coupled between the first end 110a of the support member 110 and the second end 110b of the support member 110. For example, the first end 110a may be coupled to the second end 108b of the biasing device 108 and the upright portion 106 may be coupled between the first end 110a and the second end 110b of the support member 110. The second end 108b of the biasing device 108 may be configured to contract in the unbiased state. Similarly, the second end 108b of the biasing device 108 may be configured to extend in the biased state.

The jig 202, as shown in FIG. 2, is provided as an example and is not be construed as limiting the disclosure. One skilled in the art will understand that a relative arrangement of the base portion 104, the upright portion 106, the biasing device 108, and the support member 110 may include other variations, without deviating from the scope of the disclosure.

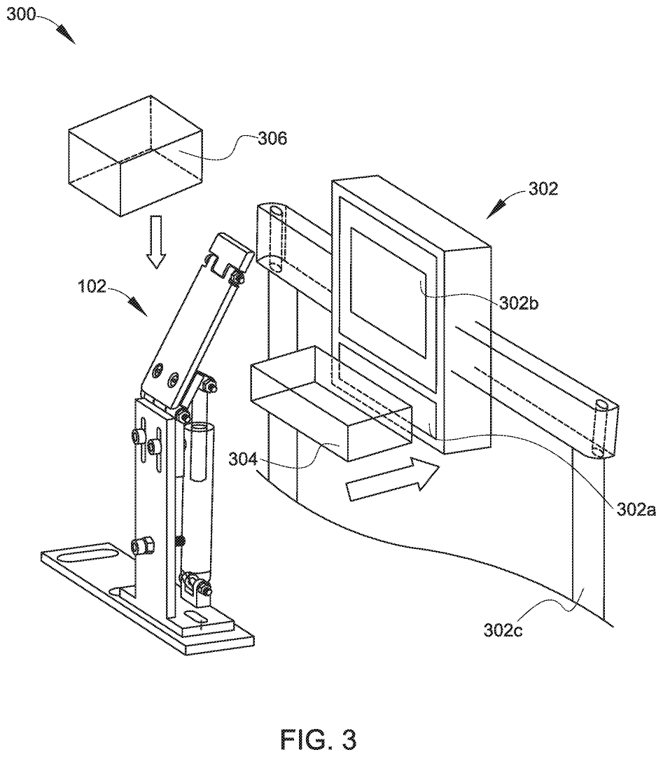

FIG. 3 is a diagram that illustrates an exemplary arrangement of the jig of FIG. 1 with an assembly interface, in accordance with an embodiment of the disclosure. FIG. 3 is explained in conjunction with FIG. 1 and FIG. 2. With reference to FIG. 3, there is shown an exemplary arrangement 300. The exemplary arrangement 300 includes the jig 102 and an assembly interface 302. The jig 102 may be configured to support a first assembly component 304 and allow a human operator to guide and then assemble the first assembly component 304 with the assembly interface 302.

The assembly interface 302 may have a suitable structure, design, or a shape profile that may be configured to accommodate the first assembly component 304 and/or a second assembly component 306. The assembly interface 302 may include a first part 302a and a second part 302b that may be supported by a suitable fixture 302c. The first part 302a may be configured to accommodate the first assembly component 304 and the second part 302b may be configured to accommodate the second assembly component 306. Although, in FIG. 3, the assembly interface 302 is shown to have a substantially cuboidal structure, one skilled in the art will understand that the assembly interface 302 may have any structural profile to match with a corresponding structural profile of the first assembly component 304 and/or the second assembly component 306.

The first assembly component 304 may be configured to be installed in the first part 302a of the assembly interface 302 through a fastening member (not shown). The fastening member may be secured at least partially by a cotter pin (not shown). Although, in FIG. 3, each of the first assembly component 304 and the second assembly component 306 is shown to have a substantially cuboidal structure, one skilled in the art will understand that each of the first assembly component 304 and the second assembly component 306 may have any suitable structural profile to match with corresponding structural profile of the first part 302a and the second part 302b of the assembly interface 302.

FIGS. 4A, 4B, and 4C are diagrams that collectively illustrate exemplary operations for installation of an assembly component into an assembly interface using the jig of FIG. 1, in accordance with an embodiment of the disclosure. FIGS. 4A, 4B, and 4C are explained in conjunction with elements from FIG. 1, FIG. 2, and FIG. 3. With reference to FIGS. 4A, 4B, and 4C, there is shown a first stage 402, a second stage 404, and a third stage 406.

In the first stage 402, the jig 102 may be in an unbiased configuration and the biasing device 108 of the jig 102 may be in the unbiased state. As shown, the second end of the biasing device 108 may extend in the unbiased state when the first end 110a is coupled to the upright portion 106 and when the second end 108b of the biasing device 108 is coupled between the first end 110a of the support member 110 and the second end 110b of the support member 110. The biasing device 108 may be positioned substantially parallel to the upright portion 106 when in the unbiased state. In an alternate embodiment, the second end 108b of the biasing device 108 may contract (using the jig 202 of FIG. 2) in the unbiased state, when the first end 110a is coupled to the second end 108b of the biasing device 108 and when the upright portion 106 is coupled between the first end 110a and the second end 110b of the support member 110.

The support member 110 may be configured to allow the first assembly component 304 to access and couple to the first part 302a of the assembly interface 302 when the jig 102 is configured to be placed adjacent to the assembly interface 302 and when the biasing device 108 is in the unbiased state. While the biasing device 108 is in the unbiased state, the first assembly component 304 may be moved towards the first part 302a of the assembly interface 302 along a first direction 402a to assemble with the assembly interface 302 through a suitable fastening member.

In the second stage 404, the second assembly component 306 may be substantially disposed on the portion 110c of the support member 110. When the second assembly component 306 is disposed on the portion 110c of the support member 110 with a substantially downward force 404a, the biasing device 108 may be configured to translate from the unbiased state to the biased state. As shown, the second end 108b of the biasing device 108 may be configured to contract (retract) in the biased state. In at least one embodiment, when in the biased state, the biasing device 108 may be configured to be inclined with respect to the upright portion 106.

In the third stage 406, the second assembly component 306 may be configured to be assembled with the assembly interface 302 when the biasing device 108 is in the biased state and the second assembly component 306 is placed on the portion 110c of the support member 110. While being placed on the portion 110c of the support member 110, the second assembly component 306 may be guided along a second direction 406a so as to be assembled with the assembly interface 302. In at least one embodiment, the pivotable end portion 110d of the support member 110 may be used to guide the second assembly component 306 along the second direction 406a.

The support member 110 may be configured to prevent a contact between the first assembly component 304 and the second assembly component 306 when the biasing device 108 is in the biased state and when the first assembly component 304 is coupled to the first part 302a of the assembly interface 302. In at least one embodiment, the first assembly component 304 may include a fastening member (not shown) secured at least partially by a cotter pin (not shown). The support member 110 may be configured to prevent an unintentional contact between the second assembly component 306 and the cotter pin while the second assembly component 306 is being assembled with the assembly interface 302. By preventing the unintentional contact, the support member 110 may prevent the second assembly component 306 from unintentionally striking and knocking off the cotter pin fastened to the first assembly component 304.

After the first assembly component 304 and the second assembly component 306 are assembled with the first part 302a the second part 302b, respectively, the substantially downward force 404a of the second assembly component 306 may be released from the portion 110c of the support member 110. When the substantially downward force 404a is released, the biasing device 108 may be configured to return to the unbiased state from the biased state.

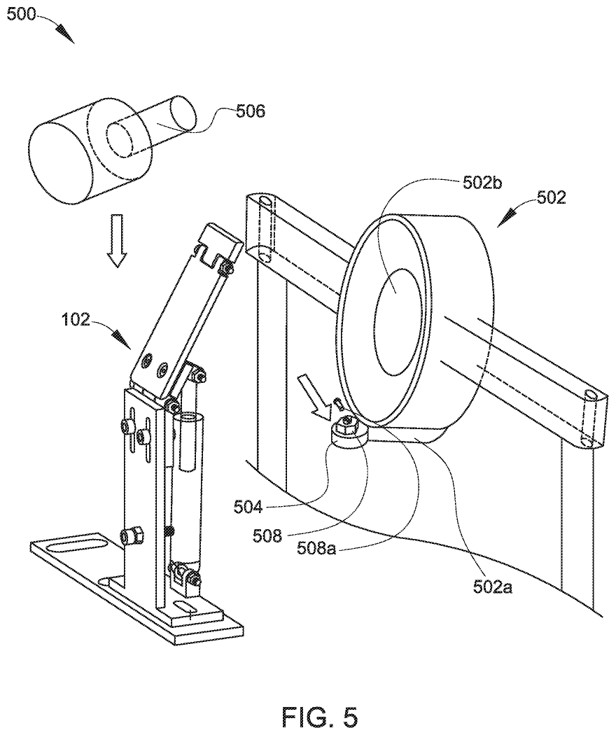

FIG. 5 is a diagram that illustrates an exemplary arrangement of a knuckle and the jig of FIG. 1 for assembly of a drive shaft with the knuckle, in accordance with an embodiment of the disclosure. FIG. 5 is explained in conjunction with elements from FIG. 1 and FIG. 2. With reference to FIG. 5, there is shown an exemplary arrangement 500 that includes a knuckle 502, a lower ball joint 504, a drive shaft 506, and the jig 102 that may be configured to guide the drive shaft 506 in the knuckle 502. Herein, the knuckle 502, the lower ball joint 504, and the drive shaft 506 may correspond to an exemplary implementation of the assembly interface 302, the first assembly component 304, and the second assembly component 306, respectively.

The knuckle 502 may have a suitable structure, design, or a shape profile that may be configured to receive the lower ball joint 504 and the drive shaft 506. The knuckle 502 may have a first part 502a and a second part 502b. The first part 502a may be configured to accommodate the lower ball joint 504 through one or more fasteners 508 and a cotter pin 508a. The cotter pin 508a may be configured to secure the one or more fasteners 508 with the lower ball joint 504. The second part 502b may be configured to accommodate the drive shaft 506.

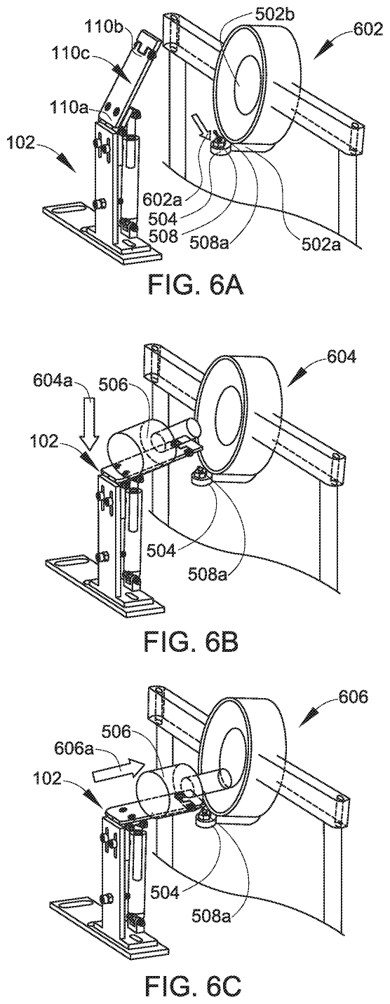

FIGS. 6A, 6B, and 6C are diagrams that collectively illustrate exemplary operations for assembly of a drive shaft with a knuckle using the exemplary arrangement of FIG. 5, in accordance with an embodiment of the disclosure. FIGS. 6A, 6B and 6C are explained in conjunction with elements from FIGS. 1, 2, and 5. With reference to FIGS. 6A, 6B, and 6C, there is shown a first stage 602, a second stage 604, and a third stage 606, as part of exemplary operations for the assembly of the drive shaft 506 with the knuckle 502 using the exemplary arrangement 500.

In the first stage 602, the jig 102 may be in an unbiased configuration and the biasing device 108 may be in the unbiased state. The jig 102 may be configured to allow the lower ball joint 504 to fasten with the first part 502a of the knuckle 502 through the cotter pin 508a in the unbiased state. For assembly, the cotter pin 508a may be moved along a first direction 602a to secure the lower ball joint 504 with the first part 502a of the knuckle 502.

In the second stage 604, the drive shaft 506 may be disposed on the portion 110c of the support member 110 with a substantially downward force 604a, causing the biasing device 108 to translate from the unbiased state to the biased state.

In the third stage 606, while the drive shaft 506 is placed on the portion 110c of the support member 110, the pivotable end portion 110d may be configured to guide a movement of the drive shaft 506 along a second direction 606a towards the knuckle 502, to assemble the drive shaft 506 with the knuckle 502. In the biased state, the support member 110 may prevent the drive shaft 506 from accessing the cotter pin 508a assembled with the lower ball joint 504 in the knuckle 502. As a result, the support member 110 may prevent the drive shaft 506 from unintentionally striking the cotter pin 508a from the lower ball joint 504.

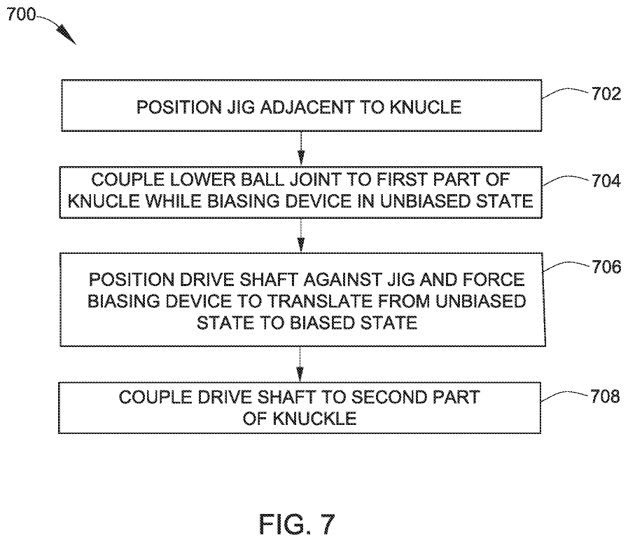

FIG. 7 is a flowchart that illustrates an exemplary method for assembling a lower ball joint and a drive shaft with a knuckle, in accordance with an embodiment of the disclosure. FIG. 7 is explained in conjunction with FIGS. 1, 2, 5, 6A, 6B, and 6C. With reference to FIG. 7, there is shown a flowchart 700 that depicts a method for assembling the lower ball joint 504 and the drive shaft 506 with the knuckle 502. The method illustrated in the flowchart 700 may start from 702.

At 702, the jig 102 may be positioned adjacent to the knuckle 502. For example, a human operator (not shown) may position the jig 102 adjacent to the knuckle 502. The jig 102 may be configured to provide access to the first part 502a of the knuckle 502 when the biasing device 108 is in the unbiased state.

At 704, the lower ball joint 504 may be coupled to the first part 502a of the knuckle 502 while the biasing device 108 is in the unbiased state 610. For example, the human operator may couple the lower ball joint 504 to the first part 502a of the knuckle 502 using the one or more fasteners 508 and the cotter pin 508a configured to secure the one or more fasteners 508.

At 706, the drive shaft 506 may be positioned against the jig 102 and the biasing device 108 may be forced to translate from the unbiased state to the biased state. For example, a lift assist may position the drive shaft 506 against the jig 102 and may force the biasing device 108 to translate from the unbiased state to the biased state 610. When the biasing device 108 is in the biased state, the jig 102 may be configured to provide the drive shaft 506, access to the second part 502b of the knuckle 502 and prevent a contact between the drive shaft 506 and the first part 502a of the knuckle 502.

At 708, the drive shaft 506 may be coupled to the second part 502b of the knuckle 502. In an embodiment, the pivotable end portion 110d of the support member 110 may guide the drive shaft 506 to couple the drive shaft 506 to the second part 502b of the knuckle 502. While assembling the drive shaft 506 with the knuckle 502, the drive shaft 506 may avoid any unintentional contact with the cotter pin 508a as the support member 110 may block access to the first part 502a of the knuckle 502.

The flowchart 700 is illustrated as discrete operations, such as 702, 704, 706, and 708. However, in certain embodiments, such discrete operations may be further divided into additional operations, combined into fewer operations, or eliminated, depending on the implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A jig, comprising:
a base portion;
an upright portion coupled to the base portion;
a biasing device comprising a first end and a second end, the biasing device is translatable between a biased state and an unbiased state, wherein the first end is rotatably coupled to at least one of: the upright portion and the base portion; and
a support member comprising a first end and a second end, the first end of the support member is rotatably coupled to at least one of the upright portion and the second end of the biasing device.

2. The jig according to claim 1, wherein the biasing device is configured to translate from the unbiased state to the biased state when a substantially downward force is applied to a portion of the support member.

3. The jig according to claim 2, wherein the biasing device is configured to return from the biased state to the unbiased state when the substantially downward force is released from the portion of the support member.

4. The jig according to claim 1, wherein, when the jig is configured to be placed adjacent to an assembly interface and when the biasing device is in the unbiased state, the support member is configured to allow a first assembly component to access and couple to a first part of the assembly interface.

5. The jig according to claim 4, wherein, when the biasing device is in the biased state and when the first assembly component is coupled to the first part of the assembly interface, the support member is configured to prevent contact between the first assembly component and a second assembly component placed on the support member.

6. The jig according to claim 5, wherein, when the second assembly component is placed on the support member and the biasing device is in the biased state, the support member is further configured to align the second assembly component and a second part of the assembly interface.

7. The jig according to claim 4, the first assembly component includes a fastening member secured at least partially by a cotter pin.

8. The jig according to claim 7, wherein the support member is configured to prevent an unintentional contact between a second assembly component and the cotter pin while the second assembly component is assembled with the assembly interface.

9. The jig according to claim 1, wherein the first end of the support member is coupled to the upright portion and the second end of the biasing device is coupled to the support member between the first end of the support member and the second end of the support member, and wherein the biasing device is configured to extend when in the unbiased state.

10. The jig according to claim 1, wherein the first end of the support member is coupled to the second end of the biasing device and the upright portion is coupled to the support member between the first end of the support member and the second end of the support member, and wherein the biasing device is configured to contract when in the unbiased state.

11. The jig according to claim 1, wherein the base portion is configured to maintain the jig in an upright position.

12. The jig according to claim 1, wherein the base portion includes at least one opening configured to receive a first fastener that fastens the base portion to a stationary surface.

13. The jig according to claim 1, wherein the upright portion includes at least one opening configured to receive a second fastener for coupling the upright portion to the support member.

14. The jig according to claim 13, wherein the second fastener is configured to slide in the at least one opening to adjust a distance between the support member and the base portion.

15. The jig according to claim 1, wherein the biasing device comprises at least one of: a pneumatic cylinder, a hydraulic cylinder, and a spring.

16. The jig according to claim 1, wherein
when the biasing device is in the unbiased state, the biasing device is configured to be positioned substantially parallel to the upright portion, and
when the biasing device is in the biased state, the biasing device is configured to be inclined with respect to the upright portion.

17. The jig according to claim 1, further comprising a pivotable end portion rotatably coupled to the second end of the support member, and
wherein the pivotable end portion is configured to be removable to ease a replacement of the pivotable end portion if the pivotable end portion is worn.

18. A jig for installation of a drive shaft, the jig comprising:
a base portion;
an upright portion coupled to the base portion;
a biasing device having a first end and a second end, wherein
the first end is rotatably coupled to at least one of: the upright portion or the base portion, and
the biasing device is translatable between a biased state and an unbiased state; and
a support member comprising a first end and a second end,
wherein the first end of the support member is rotatably coupled to at least one of: the upright portion and the second end of the biasing device, and
wherein, when a drive shaft is placed on a portion of the support member, the drive shaft is configured to apply a substantially downward force on the portion of the support member to translate the biasing device from the unbiased state to the biased state.

19. The jig according to claim 18, wherein the support member further comprises a pivotable end portion rotatably coupled to the second end of the support member, and
wherein, while the drive shaft is placed on the support member, the pivotable end portion is configured to guide a movement of the drive shaft towards a knuckle for assembly with the knuckle.

20. A method of assembling vehicle chassis components including a lower ball joint configured to be coupled to a first part of a knuckle, and a drive shaft configured to be coupled to a second part of the knuckle, the method comprising:
positioning a jig adjacent to the knuckle, the jig including a biasing device, wherein,
the jig is configured to provide access to the first part of the knuckle when the biasing device is in an unbiased state, and
the jig is configured to provide access to the second part of the knuckle and to prevent a contact between the drive shaft and the first part of the knuckle when the biasing device is in a biased state;
coupling the lower ball joint to the first part of the knuckle while the biasing device is in the unbiased state, using at least one fastener and a cotter pin configured to secure the at least one fastener;
positioning the drive shaft against the jig and forcing the biasing device to translate from the unbiased state to the biased state; and
coupling the drive shaft to the second part of the knuckle.
